(19) United States
(12) Patent Application Publication
(10) Pub. No.: US 2014/0178279 A1
(43) Pub. Date: Jun. 26, 2014

(54) AMINE ABSORBENT AND A METHOD FOR CO2 CAPTURE

(71) Applicants: Hallvard F. Svendsen, Trondheim (NO); Anastasia A. Trollebø, Trondheim (NO)

(72) Inventors: Hallvard F. Svendsen, Trondheim (NO); Anastasia A. Trollebø, Trondheim (NO)

(73) Assignee: Aker Engineering & Technology AS, Lysaker (NO)

(21) Appl. No.: 14/128,199

(22) PCT Filed: Jun. 27, 2012
(86) PCT No.: PCT/EP2012/062463

§ 371 Date: Feb. 12, 2014

(30) Foreign Application Priority Data
Jun. 27, 2011 (NO) 20110914

(51) Int. Cl. B01D 53/14

(52) U.S. Cl. CPC B01D 53/1493; B01D 53/1475
USPC 423/228; 252/190

(57) ABSTRACT

A liquid, aqueous CO₂ absorbent comprising two or more amine compounds, where the aqueous solution of amines having absorbed CO₂ is not, or only partly miscible with an aqueous solution of amines not having absorbed CO₂, where at least one of the amines is a tertiary amine, and where at least one of the amines is a primary and/or a secondary amine, wherein the tertiary amine is DEEA and the primary and/or secondary amine(s) is (are) selected from DAB, DAP, DiAP, DMPDA, HEP, or the tertiary amine is DIPAE, or N-TBDEA and primary and/or secondary amine(s) is (are) selected from DAB, DAP, DiAP, DMPDA, HEP, MAPA, and MEA, and a method for CO₂ capture using the CO₂ absorbent, are described.

### TECHNICAL FIELD

The present invention relates to improved absorbents for absorbing CO₂ from a gaseous mixture, and a method for absorbing CO₂ using said absorbents. More specifically, the present invention relates to specific amine compositions that spontaneously form two separated phases after absorbing CO₂, and a method for capturing CO₂ from gas mixtures, such as e.g. exhaust gas from combustion of carbonaceous fuels, industrial off-gases and blast furnace gases in the iron and steel production, using said amine compositions.

### BACKGROUND ART

Capture of CO₂ from a mixture of gases on an industrial scale has been known for decades, e.g. for separation of natural gas and CO₂ from sub terrain gas wells to give natural gas for export and CO₂ for return to the sub terrain structure.

The growing concern on global warming and the greenhouse effect of CO₂ from combustion of fossil fuels has caused a growing interest in CO₂ capture from major points of emission of CO₂ such as thermal power plants.

U.S. Pat. No. 5,618,506 A (THE KANSAI ELECTRIC POWER CO., AND MITSUBISHI JUKGYO KABUSHIKI KAISHA) Apr. 8, 1997, and EP 0558019 B (KANSAI ELECTRIC POWER CO, AND MITSUBISHI HEAVY IND LTD) Dec. 27, 1996, and the citations indicated therein, give a general background of processes and absorbents for capturing of CO₂.

Industrial CO₂ capturing plants include an absorber, in which a liquid absorbent is brought into counter current contact with the gas to be treated. A “purified” or low CO₂ content gas is withdrawn at the top of the absorber and is released into the atmosphere, whereas a CO₂ rich absorbent is withdrawn from the bottom of the absorber. The rich absorbent is regenerated in a regeneration column where the rich absorbent is stripped by counter current flow with steam that is generated by heating of regenerated absorbent at the bottom of the regeneration column. The regenerated absorbent is withdrawn from the bottom of the regeneration column and is recycled into the absorber. A CO₂ rich gas, mainly comprising steam and CO₂ is withdrawn from the top of the regeneration column. The CO₂ rich gas is treated further to remove water, and compressed before the CO₂ is sent for storage or other use.

Capture of CO₂ is, however, an energy demanding process, as the binding of CO₂ to the absorbent is an exothermal reaction and the regeneration is an endothermal reaction. Accordingly, heat is to be added to the regeneration column to regenerate the absorbent and release the CO₂. This heat demand is a major operating cost for a plant for CO₂ capture. A reduction of the heat requirement for regeneration of the absorbent is therefore sought to reduce the energy cost for the CO₂ capture.

Amines having a less exothermic reaction when absorbing CO₂ do, however, normally have slower reaction kinetics. Slower reaction kinetics will require a longer contact time between the CO₂ containing gas and the absorbent. A longer contact time will require a larger absorber for handling the same gas volume.

Many different amines and combinations have been suggested as absorbents for CO₂, the different amines having different CO₂ absorption capabilities, see e.g. the above mentioned patents. Additional examples on amine absorbents for capture of CO₂ and/or other acid gases from a gas mixture may be found i.a. in WO 2009/027491 A (SHELL INTERNATIONAL RESEARCH MAATSCHAPPIJ) Mar. 5, 2009, US 2008078292 A (MIMURA TOMITO) Apr. 3, 2008, and BRUDER/P, SVENDSEN, H. F. Solvent comparison for postcombustion CO2 capture. Post combustion capture conference 2011, Abu Dhabi May 2011.

The energy required to regenerate the absorbent is a major fraction of the total energy consumption for CO₂ capture. This energy is related to the heat of absorption, as the exothermic reaction taking place in the absorber will have to be reversed by addition of heat in the reboiler, and also to the shift in CO₂ equilibrium with temperature.

The energy cost is assumed to be the predominant running cost for a plant for CO₂ capture. The heat consumption is a combination of three factors (heat of absorption, heat for stripping and sensible heat loss in amine/amine exchanger).

Different approaches have been tried to improve the energy efficiency of carbon capture, such as heat integration to keep heat energy in the process and testing to find the best absorbent/mixture of absorbents.

Additionally, approaches for reducing the total mass of absorbent to be heated for regeneration, were only the CO₂ loaded part of the absorbent is sent to the regenerator, have been suggested and tested in laboratories.

US 2007237695 A (LIANG HU) Oct. 11, 2007 relates to a method and system for gas separation using a liquid absorbent absorbing one of the gases to be separated, where the absorbent spontaneously separates into a phase rich in the absorbed gas, and a phase lean in the absorbed gas. The active agent in the not identified but preferred agents is indicated to be selected from the group consisting of alkaline salts, ammonium, alkanolamines, amines, amides and combinations thereof. US 20090263302 A (LIANG HU) Oct. 22, 2009 is a continuation in part (CIP) of a CIP of US2007237695, and is further developed to indicate possible groups of active agents for the absorbent.

WO 2010/126694 A (LIANG HU) Nov. 4, 2010, relates to a method for de-acidizing an acid gas mixture using an absorbent comprising an amine dissolved in a mixture at a first concentration. After absorption of the acid gas, the absorbent forms a concentrated-amine phase, which is separated from the remainder of the absorbent and is introduced into a regeneration unit, whereas the remaining of the absorbent is recycled back into the absorption unit. A series of organic solvents are mentioned as the solvent, together with water and aqueous solutions. Organic solvents are mentioned as preferred solvents. The only exemplified absorbents are MEA in iso-octanol, which spontaneously forms a concentrated amine phase containing MEA and the reaction product of MEA and CO₂, and an aqueous carbonate solution which forms insoluble bicarbonate on absorption of CO₂.

WO 2010/044836 A (LIANG HU) Apr. 22, 2010, relates to a method for de-acidizing an acid gas mixture using an absorbent comprising a carrier phase and an organic phase that is immiscible with the carrier phase. Introduction of an organic solvent as described herein is unwanted, mixed solvent systems add complexity to the systems.

U.S. Pat. No. 7,541,011 B (LIANG HU) Jun. 2, 2009, relates to a method for separating a gas from a gas mixture, using an absorbent comprising at least one activated agent and at least one solvent. The only exemplified activated absorbent is an aqueous mixture of DEA and potassium carbonate, where the solvent causing the intended phase separation and constituting about 80% of the volume of the absorbent, is unspecified.

An objective of the present invention is to provide an improved absorbent and an improved method for capturing of CO₂ from a CO₂ containing gas using the absorbent, where the improved absorbents have improved characteristics with regard to the criteria mentioned above, compared with the prior used absorbents, such as exemplified with the MEA reference absorbent. Specifically, it is an object to provide an absorbent having a low energy requirement and good chemical stability. It is also an object to provide a method for use of the new absorbent which makes use of these characteristic and results in low energy consumption with minimal environmental impact. Other objects of the invention will be clear by reading the description.

### DISCLOSURE OF INVENTION

According to a first aspect, the present invention relates to a liquid, aqueous CO2 absorbent comprising two or more amine compounds, where the aqueous solution of amines having absorbed CO2 is not, or only partly miscible with an aqueous solution of amines not having absorbed CO2, where at least one of the amines is a tertiary amine, and where at least one of the amines is a primary and/or a secondary amine, wherein the tertiary amine is DEEA and the primary and/or secondary amine(s) is (are) selected from DAB, DAP, DiAP, DMPDA, HEP, or the tertiary amine is DIPAE, or N-TBDA and primary and/or secondary amine(s) is (are) selected from DAB, DAP, DiAP, DMPDA, HEP, MAPA, and MEA. These combinations of a tertiary and primary and/or secondary amine(s) that are miscible and form a single phase mixture before absorption of CO₂, have been found spontaneously to separate into a CO₂ rich phase and a CO₂ lean phase after absorption of CO₂. This phase separation makes it possible to separate the CO₂ rich phase from a CO₂ lean phase for regeneration of the CO₂ rich phase only, and recycle the CO₂ lean to the absorber.

Regeneration of the amine absorbent comprises heating of the rich absorbent for reversing the exothermal CO₂ absorption to release the CO₂. Reduction of the volume to be heated during the regeneration reduces the heat demand for heating the absorbent. Even though heat exchanging is extensively used to recover heat and reduce heat loss, the heat loss in the regeneration step is substantial. Reduction of the volume to the heated reduces the heat demand for heating of water and lean amine, and accordingly reduces the heat loss from the total process.

According to a second aspect, the present invention relates to a method for capturing CO2 from a CO2 rich gaseous, the method comprising the steps of:
introducing the CO2 rich gas into an absorber in which the gas is brought into counter current contact with a liquid, aqueous CO2 absorbent comprising a combination of a tertiary amine and a primary or amine amine, where the tertiary amine is DEEA and the primary and/or secondary amine(s) is (are) selected from DAB, DAP, DiAP, DMPDA, HEP, or the tertiary amine is DIPAE, or N-TBDA and primary and/or secondary amine(s) is (are) selected from DAB, DAP, DiAP, DMPDA, HEP, MAPA, and MEA, to absorb the CO2 in the gas stream to produce a depleted gas stream,
releasing the gas stream depleted from CO2 into the surroundings,
collecting the absorbent at the bottom of the absorber,
allowing the absorbent separate into a CO2 rich absorbent phase, and a CO2 lean absorbent phase:
withdrawing the CO2 lean absorbent phase and recycling the lean absorbent phase into the absorber,
withdrawing the CO2 rich absorbent phase and introducing the rich absorbent into a stripper column for regeneration of the CO2 rich to release CO2, that is withdrawn and further treated for storage, to give a CO2 lean absorbent that is recycled to the absorber.

Preferred embodiments of the two aspects of the invention is identified in the dependent claims.

### BRIEF DESCRIPTION OF DRAWINGS

FIG. 1 is a principle drawing of a CO₂ capture plant according to the invention,

FIG. 2 is an absorption curve for exemplary absorbents according to the present invention, compared with MEA

FIG. 3 is an absorption curve for other exemplary absorbents according to the invention, compared with MEA,

FIG. 4 is a plot of CO₂ pressure as a function of temperature,

FIG. 5 is a plot of heat of reaction for one absorbent system,

FIG. 6 is a plot of vapour pressure as a function of for some amines in pure form, and

FIG. 7 shows three plots of activity coefficient (γᵢ) as a function of concentration for DIPAE in water at different temperatures.

### DETAILED DESCRIPTION OF THE INVENTION

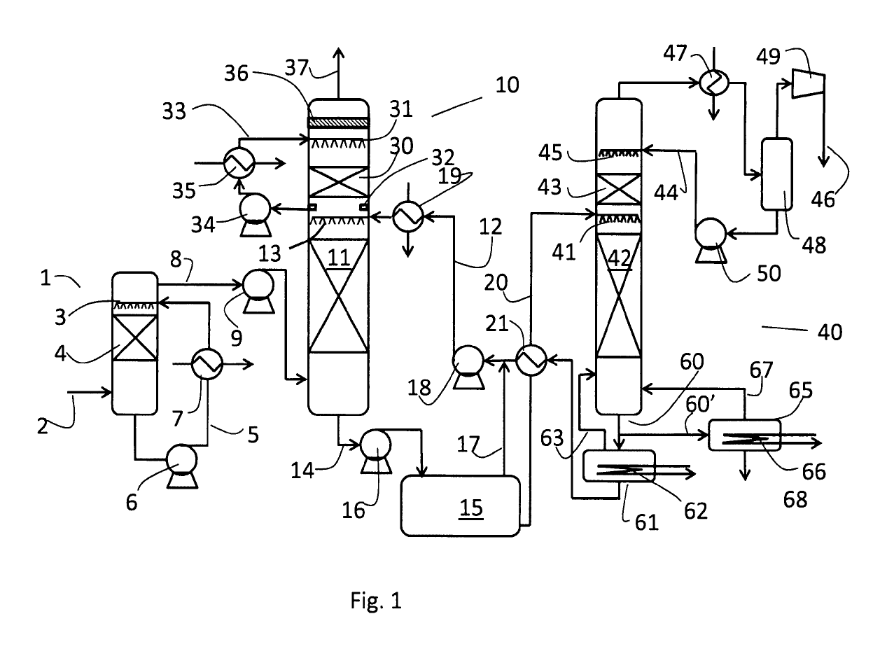

FIG. 1 is a principle drawing of a plant for CO₂ capture using the absorbent according to the present invention. CO₂ containing gas, such as exhaust gas from a power plant fired by carbonaceous fuel, or any other CO₂ containing gas, is introduced into an optional direct contact cooler 1 through an exhaust line 2 arranged to the lower part of the direct contact cooler. The exhaust gas is cooled and humidified by water introduced through a water distributor 3, such as nozzles, trays, packing or the like, so that exhaust gas streaming upwards in the cooler is brought in contact with the water. A packing 4 is preferably arranged in the direct contact cooler 1 to improve the contact between the water and the exhaust gas during the counter current flow of water against exhaust gas.

Cooling water for the direct contact cooler is withdrawn from the bottom of the direct contact cooler and re-circulated in a washing water re-circulation line 5 by means of a pump 6. A cooler 7 for cooling the washing water against cooling water is preferably arranged in the re-circulation line 5. The skilled person will understand that non-shown lines for adding make-up water and/or adjusting the pH of the circulating water, preferably are arranged to the re-circulation line.

Cooled and humidified exhaust gas is withdrawn from the direct contact cooler through a line 8 and a blower 9 and introduced into the lower part of an absorber 10. The exhaust gas is flowing upwards in the absorber and is caused to flow in counter current contact with a liquid absorbent in a packing 11. The skilled person will understand that the packing 11 may be any convenient packing allowing or maximizing intimate contact between the exhaust gas and the liquid absorbent. Additionally, the packing may be divided in two or more serially connected parts.

Absorbent is introduced into the absorber 10 from a lean absorbent line 12 and is distributed to the top of the packing 11 from absorbent distributor 13, and is allowed to trickle through the packing below to absorb CO₂ from the exhaust gas streaming upwards.

The absorbent is introduced into the absorber either as a substantially homogenous liquid that may comprise some discontinuous phase that is not or partly miscible with the main liquid phase, or as a bi-phasic aqueous solution containing two CO₂ lean not or partly miscible phases.

For absorbents that are present in one phase when CO₂ lean, two immiscible phases form in absorbing CO₂ from the exhaust gas, and the rich absorbent phase having absorbed CO₂ becomes immiscible with the CO₂ lean absorbent.

For absorbents being biphasic when lean in CO₂, both phases absorb CO₂. As the total CO₂ content increases, certain components from the CO₂ lean phase transfer to the CO₂ rich phase, thereby producing steadily more CO₂ rich phase while maintaining a high absorption rate throughout the process.

The exhaust gas leaving the packing 11 is CO₂ depleted as more than 80%, more preferably more than 85%, such as more than 90%, of the CO₂ originally present in the exhaust gas, is absorbed by the absorbent. The CO₂ depleted exhaust gas is then washed in one or more washing section(s) each of which comprising a washing packing 30 in which the CO₂ depleted exhaust gas is washed in counter current flow to water, or an aqueous acid solution to remove any amines and degradation products of amines from the gas.

Washing water is introduced to the top of the washing section through liquid distributor 31. Washing water is collected by liquid collector 32 below the washing section and withdrawn through a washing water recycle line 33. A pump 34 and a cooler 35 are arranged to the recycle line 33. Not shown make-up water line, and/or pH adjustment line may also be arranged to the recycle line 33. A demister 36 is preferably arranged above the washing section to remove droplets of water following the cleaned exhaust gas, before the cleaned exhaust gas is released to the surroundings through a cleaned exhaust line 37.

The absorbent is collected at the bottom of the absorber and transferred through an absorbent withdrawal line 14 into a separation unit 15. A pump 16 may be provided in the absorbent withdrawal line 14.

The CO₂ rich phase of the absorbent is separated from the CO₂ lean absorbent by means of gravity or other separation in the separation unit 15, as the CO₂ rich phase is heavier than the CO₂ lean phase. The lightest, or CO₂ lean, phase is withdrawn from the separation unit 15 through a recycle line 17 and re-cycled to the lean absorbent line as a part of the lean absorbent introduced into the absorber. A lean absorbent pump 18 for pumping the lean absorbent, and a cooler 19 for cooling the lean absorbent are preferably arranged on the lean absorbent recycle line 12.

The heavy, CO₂ rich phase from the separation unit 15 is withdrawn through a rich absorbent line 20. The rich absorbent in line 20 is heated in a heat exchanger 21 against lean absorbent in line 12 as described in further details below, and is introduced into a regeneration column 40 via rich absorbent distributor 41, is caused to flow counter current to steam in a packing 42 arranged in the regeneration column below the distributor 41, and is collected at the bottom of the regeneration column 40.

The CO₂ rich absorbent introduced into the regeneration column is stripped by the counter current flow of steam to release CO₂ that streams upwards together with the steam. The stream of CO₂ and steam flowing upwards in the regeneration column is washed by counter current flow to water in a packing 43. Washing water is introduced from a water return line 44 into a washing water distribution device 45. CO₂ and steam that have been washed in the packing 43 are withdrawn from top of the regeneration column and cooled, dried and compressed before the captured CO₂ is withdrawn from the plant through a CO₂ line 46.

Cooling, drying and compression are illustrated by means of a cooler 47, a flash tank 48 and a compressor 49. The skilled person will, however understand that the final treatment of CO₂ comprises several cooling, flashing and compression steps. Water removed during the drying of the gas phase withdrawn from the regeneration column is, preferably, collected, and returned as washing water in line 44. A pump 49 is normally provided to recycle the water and pump the water into the washing water distributor 45.

Regenerated, or lean absorbent, is withdrawn from the regeneration column through an absorbent drain line 60 and is led into a reboiler 61 heated by a heating coil 62, normally heated by steam at about 130° C. Steam comprising a mixture of water steam and gaseous amine is withdrawn through a steam line 63 and introduced into the regeneration column as stripping gas to heat and strip the rich amine. Liquid absorbent is withdrawn through lean absorbent line 12 and cooled by heat exchanging against rich absorbent as mentioned above.

A part stream is preferably withdrawn from the absorbent drain line 60 through a reclaimer line 60′ and introduced into a reclaimer 65 where the absorbent is heated by means of a heat coil, preferably by use of steam, and boiled, optionally in presence of additional chemicals such as acids, to liberate insoluble amine salts, to reclaim amines that are withdrawn as gas together with steam through a reclaimed absorbent line 67. The gas in the reclaimed absorbent line 67 is introduced into the regeneration column as stripper gas, whereas remaining liquid phase is withdrawn from the reclaimer 65 together with insoluble salts and degradation products through a waste absorbent line 68 and sent for deposition or degradation to more environmentally acceptable products.

The skilled person will understand that the liquid distributor 3, 13, 31, 41, 45 may be any convenient liquid distributor such as nozzle tubes, trays etc.

The separation unit 15 may in its simplest embodiment be a settling tank but can also be a centrifugal separator such as a cyclone or a centrifuge, to accelerate the separation.

The present absorbent is an aqueous solution of two or more absorbing amine compounds, as defined in the claims. Before absorption of CO₂, i.e. in the lean, or CO₂ poor state, the absorbent may be a substantial homogeneous aqueous solution, or may comprise two immiscible or partly miscible aqueous phases. After having absorbed CO₂, the absorbent spontaneously separates into two immiscible phases, one phase mainly comprising lean absorbent, i.e. absorbent not having absorbed CO₂, and one phase mainly comprising rich absorbent, i.e. absorbent having absorbed CO₂. Both phases are still aqueous solutions.

When the aqueous absorbent is brought in contact with CO₂, CO₂ is absorbed physically, chemically or by a combination thereof in an exothermal reaction to alter the composition of the absorbent. The absorbent according to the present invention spontaneously forms two partly miscible or immiscible phases on absorption of CO₂, one CO₂ lean phase and one CO₂ rich phase.

For a substantially homogeneous solvent entering the absorber, the separation into two phases starts during the absorption phase, i.e. when the absorbent is in contact with gaseous CO₂ in the absorber. The CO₂ lean phase works here as a reaction reservoir and enhancer for the CO₂ absorption, whereas the CO₂ rich phase accumulates CO₂ up to a very high loading by steadily receiving absorbing components from the CO₂ lean phase. The volume ratio of CO₂ lean to CO₂ rich phase will thus decrease as the CO₂ content increases. If the liquid feed to the absorber already contains two immiscible or partly miscible phases, the working mechanism is exactly the same.

The phases differ in density, where the CO₂ rich phase is heavier than the CO₂ lean phase, allowing the phases to be separated by density, such as e.g. in a settling tank. The spontaneous separation in the separator is relatively quick and efficient. If necessary, the separation may be accelerated by means of centrifugal separators, or other gravity enhancing means.

By separating the phases and returning the CO₂ lean absorbent directly to the absorber, and regenerating only the rich absorbent, i.e. the absorbent having absorbed most CO₂, less absorbent has to be heated. Accordingly, the above mentioned sensible heat demand for the regeneration is substantially reduced. As the sensible heat loss for heating up the circulation phase to the desorber outlet temperature is lowered in proportion to the reduction in flow, the present invention let us to reduce energy consumption for the CO2-stripping step. At the same time, circulation of CO₂-lean phase directly to the absorption unit provides good wetting of the gas-liquid contact surface inside the absorption unit, thus providing high absorption rate and effective gas-liquid mass-transfer.

CO2-rich phase is the only phase sent to the regeneration unit. In the desorption unit CO2-rich phase is heated up to the stripping conditions, when absorbed CO2 is regenerated from the CO2-rich solution. Sending only CO2-rich phase to the CO2-stripping step allows the highly concentrated solution to be regenerated alone. Heating this solution up to normal stripping temperatures of 115-125° C. provides CO₂ partial pressures greatly exceeding those encountered under normal operation with e.g. MEA. This reduces the heat needed for stripping steam generation to a small fraction of that normally needed for e.g. MEA. The heat needed for stripping steam is normally a substantial part of the total heat demand, e.g. 40%, and this may be lowered to close zero.

The absorbent systems developed are all systems containing two or more absorbent components. One of the absorbent components will be an active component proving the high absorption rate needed for obtaining a close approach to equilibrium at the absorber outlet (bottom). Another component will provide the CO₂ loading capacity while transferring from the CO₂ lean phase to the CO₂ rich phase during absorption. This absorbent component may have a low heat of reaction, and will thus provide a reduction in heat needed for reversion of the CO₂ absorption reaction in the regenerator, while the active component still maintains the absorption rates in the absorber. This property allows also a reduction in the heat of reaction reversion compared to what is found e.g. for MEA.

Another way of exploiting the properties of the developed absorbent systems is to perform the regeneration at reduced temperature. The developed absorbent systems provide a high partial pressure of CO₂ even at temperatures down to 80-90° C. These allow regeneration at these and possibly even lower temperatures. Regeneration at 80-90° C. opens up a possibility for use of waste heat or externally generated heat, e.g. solar heat, for regeneration and may thus lead to processes without a need for heat extraction from the power production process

The behaviour of the absorbents depends on the choice of CO₂ absorbing species, the ratio between the species and the total concentration thereof.

Even though it is expected that a plurality of absorbent mixtures may separate spontaneously into a CO₂ lean phase and a CO₂ rich phase, the studies leading to the present invention have identified a limited number of preferred absorbents.

Table 1, below, identifies the amines used in the present studies, the common abbreviation, molecular weight and CAS No., for each of them:

TABLE 1

| Chemical name | Abbreviation | MW | CAS No. |
|---|---|---|---|
| 1,4-diaminobutane | DAB | 88.15 | 110-60-1 |
| 1,3-diamino-2-propanol | DAP | 90.12 | 616-29-5 |
| 2-diethylamino-ethanol | DEEA | 117.19 | 100-37-8 |
| 1,3-propanediamine | DiAP | 74.12 | 109-76-2 |
| 2-diisopropylamino-ethanol | DIPAE | 145.24 | 96-80-0 |
| 2,2-dimethyl-1,3-propanediamine | DMPDA | 102.18 | 7328-91-8 |
| 1-piperazineethanol | HEP | 130.19 | 103-76-4 |
| N1-methyl-1,3-Propanediamine | MAPA | 88.15 | 6291-84-5 |
| 2-amino-ethanol | MEA | 61.08 | 141-43-5 |
| N-tert-butyldiethanolamine | N-TBDEA | 161.24 | 2160-93-2 |

The present absorbents are aqueous solutions of two or more CO₂ of the amines mentioned above. Table 2, below, shows the tested absorbents:

TABLE 2

| Absorbent | | | |
|---|---|---|---|
| No. | Constituents | Ratio | Comment |
| System 3 | DIPAE/MAPA | 4:2 | Single phase before CO2 |
| | | | absorption, two liquid |
| | | | phases after absorption |
| System 4 | DEEA/MEA | 4:2 | Two liquid phases before |
| | | | and after absorption |
| System 6 | DIPAE/DiAP | 3:1 | Two liquid phases before |
| | | | and after absorption |
| System 7 | DIPAE/MEA | 4:2 | Two liquid phases before |
| | | | and after absorption |
| System 8 | DIPAE/DiAP | 4:2 | Two liquid phases before |
| | | | and after absorption |
| System 9 | DIPAE/DAB | 4:2 | Single phase before CO2 |
| | | | absorption, two liquid |
| | | | phases after absorption |
| System 10 | DIPAE/MAPA | 1:1 | Two liquid phases before |
| | | | and after absorption |
| System 10b | DIPAE/MAPA | 2:1 | Two liquid phases before |
| | | | and after absorption |
| System 11 | T-TBDEA/MAPA | 4:2 | Two liquid phases before |
| | | | and after absorption |
| System 12 | N-TBDEA/DiAP | 4:2 | Single phase before CO2 |
| | | | absorption, two liquid |
| | | | phases after absorption |
| System 21 | DIPAE/HEP | 4:1 | Two liquid phases before |
| | | | and after absorption |
| System 22 | DEEA/DMPDA | 5:2 | Single phase before CO2 |
| | | | absorption, two liquid |
| | | | phases after absorption |

30% MEA was used as a reference absorbent in the examples.

### EXAMPLES

### Example 1

### Systems Showing One Liquid Phase Before Absorption and Two Liquid Phases after Absorption

CO₂ loading and CO₂ absorption rate at 40° C. were measured according to standard procedures for different absorbent mixtures according to the present invention and for 30% MEA, and absorption curves were plotted. The standard measuring procedure for CO₂ is by precipitation of barium carbonate (BaCO₃) using addition of 0.5 M barium chloride (BaCl₂) and 0.1 M sodium hydroxide (NaOH).

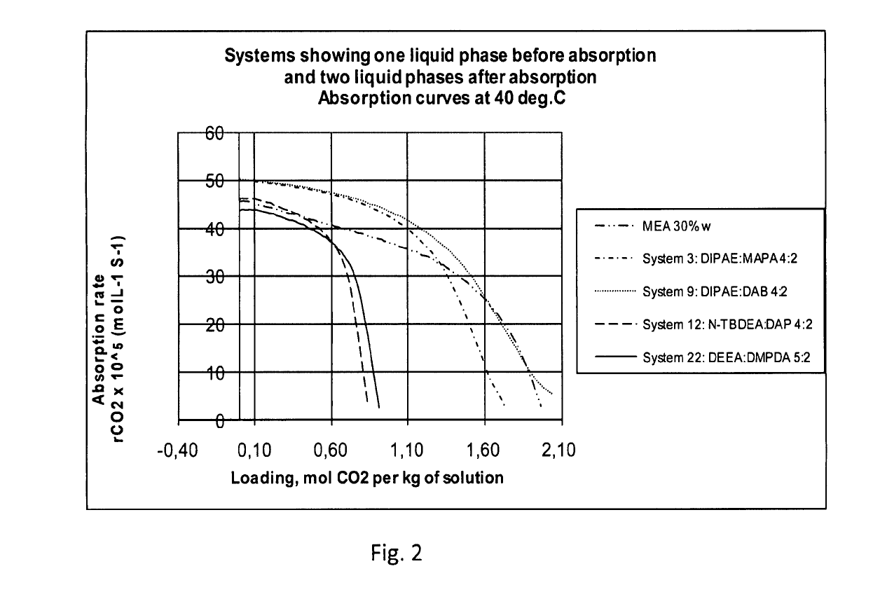

FIG. 2 illustrates absorption curves for MEA and the absorbents mainly comprising one phase in CO₂ lean condition. We see that the rate of absorption in the low loading range is better that for MEA and that this is retained to high CO₂ loadings. It should be noted that the CO₂ loading is given based on kg mixed solution and that the CO₂ rich phase will be 2-4 times more concentrated.

### Example 2

### Systems Showing Two Liquid Phases Before Absorption and Two Liquid Phases after Absorption

CO₂ loading and CO₂ absorption rate at 40° C. were measured according to standard procedures (see below]) for different absorbent mixtures according to the present invention and for 30% MEA, and absorption curves were plotted

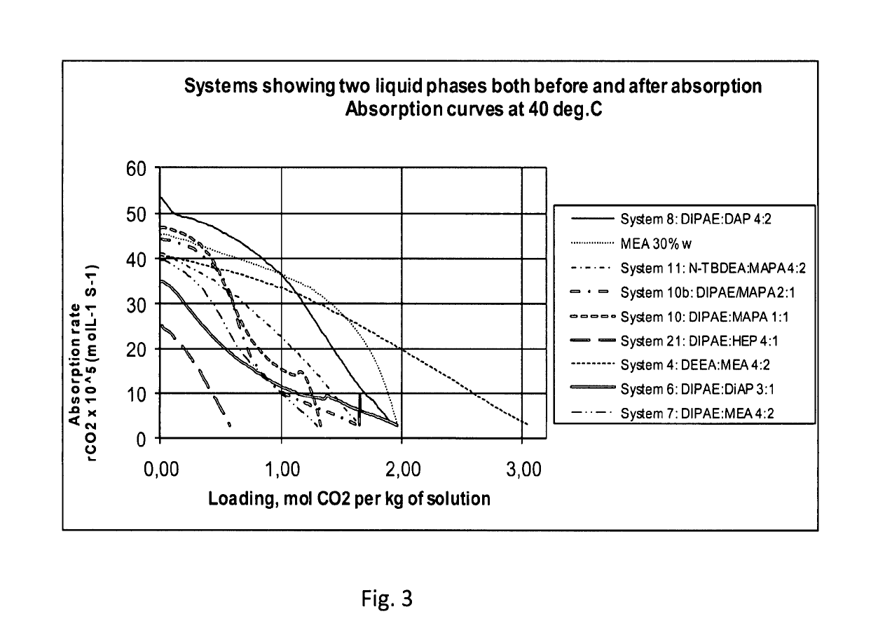

FIG. 3 illustrates absorption curves for absorbents that comprises two phases both when being CO₂ lean and after CO₂ absorption. Also in this case the CO₂ loading is per kg of solvent and several of the systems have higher or equally high absorption rate compared to 30% MEA.

What happens during absorption is the same whether one starts with one or two liquid phases. As soon as two liquid phases are formed most of the CO₂ will accumulate in the ionic bottom phase. The upper phase will act as a reservoir for tertiary amine, and this will transfer to the lower phase as it loads up.

### Example 3

### Stripping Pressure for DIPAE:MAPA, 4:2

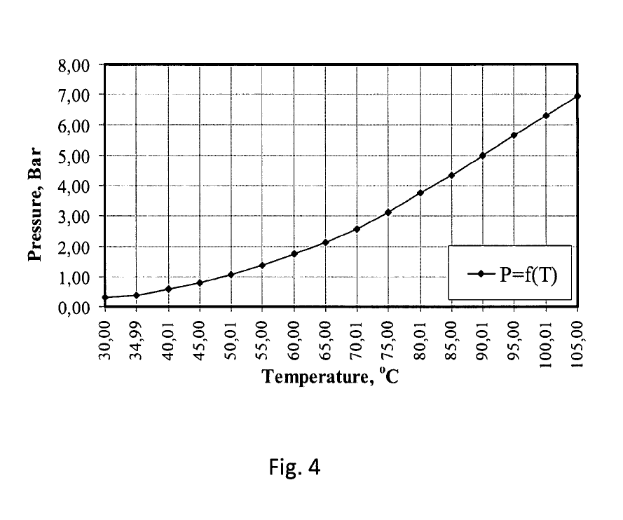

The CO₂ partial pressure over CO₂ rich absorbent bottom phase as a function of temperature was measured. CO₂ partial pressure over the rich phase of “system 3” absorbent as a function of temperature is plotted in FIG. 4.

FIG. 4 clearly shows that the tested absorbent allows stripping at elevated pressures, thus reducing energy consumption for the further CO₂ compression and pipeline transportation steps.

### Example 4

### Heat of Desorption for DIPAE:MAPA, 4:2

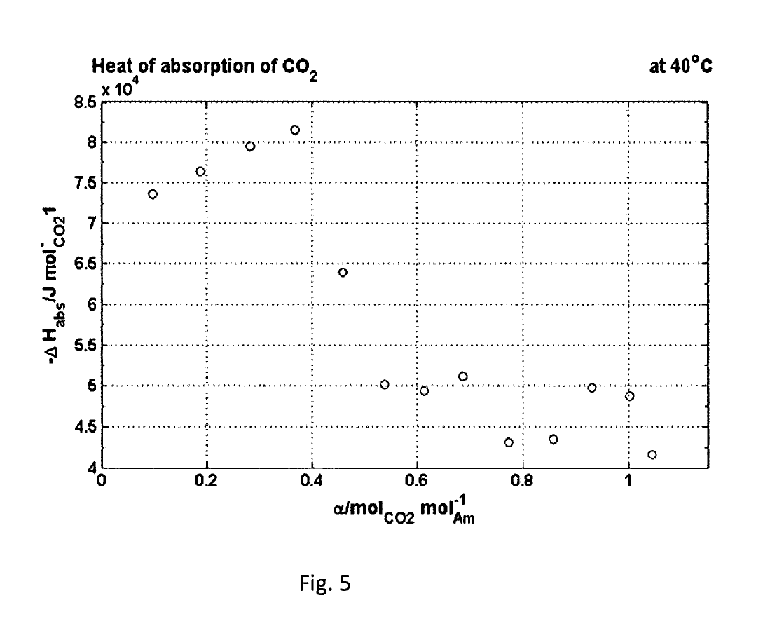

Heat of desorption at the stripping of the CO2-rich phase lies in the low heat of reaction region, thus reducing amount of energy required for the CO₂-stripping step. It allows working in the region of optimal loading, remaining in the region of low heat of reaction, obtaining higher energy efficiency of whole process. As shown in FIG. 5 “Heat of reaction for System 3”, this region lies in the loading range from 0.4 to 1 mol CO₂/mol of amine.

### Example 5

### Cyclic Capacity for DIPAE:MAPA, 4:2

CO₂-rich phase after the CO₂-stripping step becomes regenerated CO₂-rich phase. Regenerated CO₂-rich phase is sent back to the absorption unit. And so, the process is cycled.

The desorbed CO₂ gas is either collected or sent to the customer pipeline.

The purified gas-mixture is collected or disposed of depending on the purpose of the user.

Absorbent system 3 was tested for CO₂ loading per mol of amine in the absorbent. It was found that the CO₂ lean, or lower phase, has a loading of 0.014 mol CO₂/mol amine, whereas the CO₂ rich or lower phase has a loading of 1.49 mol CO₂ per mol amine. An absorption capacity of close to 1.5 mol CO₂ per mol of amine is a high cyclic capacity of absorbent.

### Experiment 6

### Vapour Pressure Over Amines at Varying Temperature

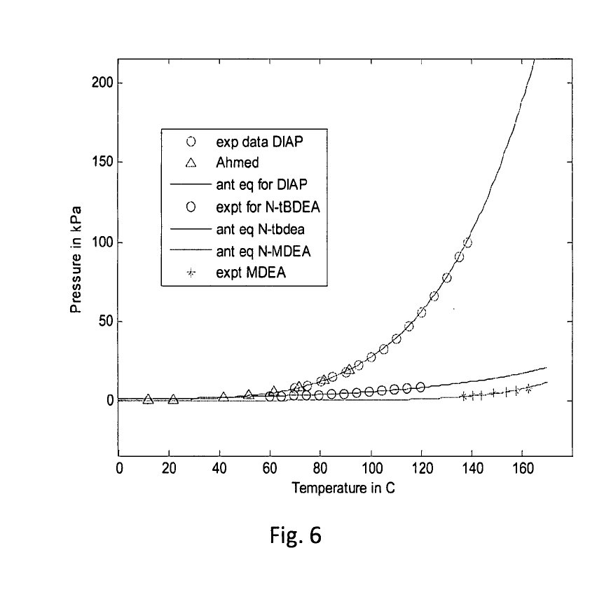

Vapour pressure of the secondary amine DIAP, and the tertiary amine N-TBDEA were measured as a function of temperature and potted in FIG. 6. The data points are measured values, whereas the lines are calculated values. Values for MDEA which is not a part of the present invention, is also included for comparison.

FIG. 6 clearly shows that the vapour pressure of DIAP increases substantially from the typical value found in an absorber of a CO₂ capture plant, to the temperature typically found in the regeneration column. As a result of this substantial difference, the vapour pressure of DIAP in the absorption column will be relatively low, resulting in a relatively low amine partial pressure, whereas the amine (DIAP) partial pressure will be substantially higher in the regeneration column, a fact that will result in that the DIAP will constitute a substantial part of the stripping gas in the regeneration column. As the heat of evaporation of DIAP is substantially lower than for water, this will reduce the regeneration heat needed for the regeneration.

As the partial pressure in the absorber is low, the problems with amine slip, i.e. loss of amine together with the cleaned exhaust gas, will be low under normal circumstances.

### Example 7

### Activity Coefficient for DIPAE at Different Temperatures

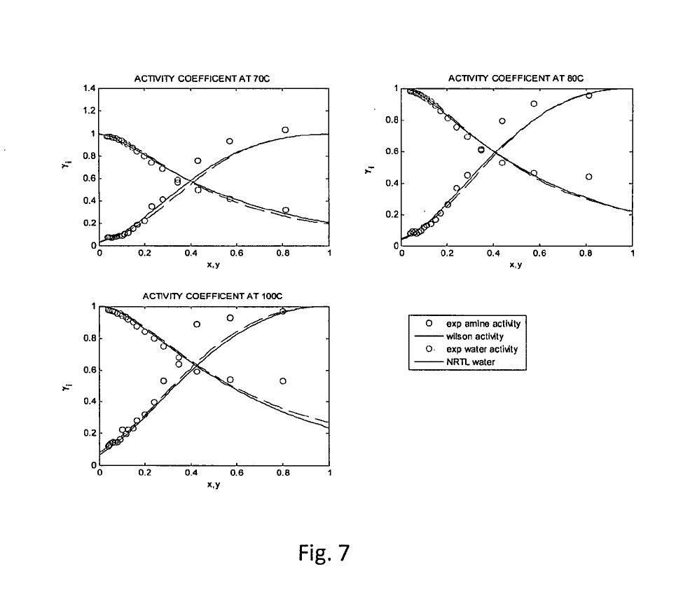

The reactivity coefficient of DIAP, as a typical example of a primary or secondary amine according to the present invention, in aqueous solution. The concentration of amine is in FIG. 7 plotted against the activity coefficient, at temperatures of 70, 80 and 100° C. Circles indicate measured points, whereas the lines indicate calculated values.

The results indicates that DIAP, as a representative for the amines used in the claimed process have the property of very low activity coefficient at low concentrations, as shown in FIG. 7. This is a large advantage as one may operate with amine with higher pure amine vapour pressure and still have a low actual vapour pressure in the absorber, thus making the avoidance of amine vapour out of the absorber easier to handle. The claimed amine systems also have the property of increasing activity coefficient with temperature. This implies that the effect of replacing water as “stripping steam” in the regenerator while still maintaining low actual vapour pressure in the absorber can be achieved with these systems.

### Discussion

Separation of rich and lean absorbent allows for sending the rich absorbent only to regeneration, which again results in lower circulation rate for the CO₂-rich phase, thus obtaining reduced energy consumption for the pumping operation.

It was found that two-phase forming absorbents are showing high absorption rate, lower heat of absorption, higher CO₂ pressure at the desorption stage and thus lower energy demand for whole process.

Screening results for exemplary absorbents, or absorption systems, are provided, indicating promising properties and potential for obtaining advantageous results for a carbon capture plant.

The test results also give indications of equilibrium and absorption rates, compared to 30% weight MEA.

The provided analysis of CO₂-content for the two phases obtained after CO₂ capture clearly shows a high CO₂ concentration in the rich phase compared to concentration reached in ordinary single phase absorption. This property allows for high CO₂ capture capacity at the same time as the amount of rich absorbent circulated through the regeneration column is reduced. Reduction of the volume of absorbent circulated through the regeneration column reduces the heat demand for heating the rich absorbent in the regeneration column.

The plot of total pressure over the rich solution as function of temperature shows a CO₂ pressure of about 7 bars can be obtained at 105° C. or nearly 4 bars at 80° C. By obtaining CO₂ at an elevated pressure from the regeneration column, the energy input needed for compressing the captured CO₂ before being exported from the capture plant is substantially reduced.

Using a lower regenerator temperature of 80° C. could allow the use of waste or externally generated heat, alleviating the need for steam extraction from a power station.

The plot of the values for heat of reaction for absorbent system 3 found in FIG. 5, shows advantageous heat of reaction properties. A sudden drop in the heat of reaction drops to values typical of tertiary amines is observed after starting at high values typical for primary and secondary amines at low loadings. The present absorbent systems, as illustrated by system 3, have therefore a surprisingly low heat of reaction in the region for industrial operation of a carbon capture plant.

The screening results show that the system maintains its rate of absorption to quite high loading implying that, even if at higher loading it is the tertiary amine that reacts, the rate of absorption is more like a secondary or primary amine. Thus it may seem that we can have the speed of a secondary or primary amine, combined with the heat of absorption of a tertiary amine.

1. A liquid, aqueous C0₂ absorbent comprising:
two or more amine compounds, where a first aqueous solution of amines having absorbed C0₂ is not, or only partly miscible with a second aqueous solution of amines not having absorbed C0₂;
wherein at least one of the amines is a tertiary amine;
where wherein at least one of the amines is a primary and/or a secondary amine;
wherein the tertiary amine is DEEA and the primary and/or secondary amine(s) is (are) selected from DAB, DAP, DiAP, DMPDA, HEP, or the tertiary amine is DIPAE, or N-TBDEA and primary and/or secondary amine(s) is (are) selected from DAB, DAP, DiAP, DMPDA, HEP, MAPA, and MEA.

2. The liquid, aqueous C0₂ absorbent according to claim 1, wherein the tertiary amine is DEEA.

3. The liquid, aqueous C0₂ absorbent according to claim 1, wherein the tertiary amine is DIPAE.

4. The liquid, aqueous C0₂ absorbent according to claim 1, wherein the tertiary amine is N-TBDEA.

5. A method for capturing C0₂ from a C0₂ rich gas, the method comprising:
introducing the C0₂ rich gas into an absorber in which the C0₂ rich gas is brought into counter current contact with a liquid, aqueous C0₂ absorbent comprising a combination of a tertiary amine and a primary or secondary amine, where the tertiary amine is DEEA and the primary and/or secondary amine(s) is (are) selected from DAB, DAP, DiAP, DMPDA, HEP, or the tertiary amine is DIPAE, or N-TBDA and primary and/or secondary amine(s) is (are) selected from DAB, DAP, DiAP, DMPDA, HEP, MAPA, and MEA, to absorb the C0₂ in the gas stream to produce a depleted gas stream, releasing the gas stream depleted from C0₂ into the surroundings,
collecting the liquid, aqueous C0₂ absorbent at the bottom of the absorber,
allowing the liquid, aqueous C0₂ absorbent separate into a C0₂ rich absorbent phase, and a C0₂ lean absorbent phase:
withdrawing the C0₂ lean absorbent phase and recycling the lean absorbent phase into the absorber,
withdrawing the C0₂ rich absorbent phase and introducing the C0₂ rich absorbent into a stripper column for regeneration of the C0₂ rich absorbent to release C0₂, that is withdrawn and further treated for storage, to give the C0₂ lean absorbent that is recycled to the absorber.

6. The method of claim 5, wherein the tertiary amine is DEEA.

7. The method of claim 5, wherein the tertiary amine is DIPAE.

8. The method of claim 5, wherein the tertiary amine is N-TBDA.
